(19) United States
(12) Patent Application Publication
(10) Pub. No.: US 2015/0316798 A1
(43) Pub. Date: Nov. 5, 2015

(54) SEALANT, PREPARING METHOD AND USE METHOD THEREOF AND LIQUID CRYSTAL DISPLAY PANEL

(71) Applicants: BOE TECHNOLOGY GROUP CO., LTD., Beijing (CN); BEIJING BOE OPTOELECTRONICS TECHNOLOGY CO., LTD., Beijing (CN)

(72) Inventors: Xiaojuan WU, Beijing (CN); Wei LI, Beijing (CN)

(21) Appl. No.: 14/529,193

(22) Filed: Oct. 31, 2014

(30) Foreign Application Priority Data
May 4, 2014 (CN) 201410185170.1

(51) Int. Cl. G02F 1/1339; G02F 1/1335; C09J 131/04

(52) U.S. Cl. CPC G02F 1/1339; C09J 131/04; G02F 1/133514; G02F 2202/28

(57) ABSTRACT

The invention discloses a sealant, preparing method and use method thereof, and a liquid crystal display (LCD) panel, which can solve the problem that the sealant in the LCD panel of the prior art is apt to contaminate the liquid crystal adjacent thereto. The sealant of the invention comprises a sealant base composition and an ethylene-vinyl acetate copolymer, which is a linear polymer with a high molecular weight, and which is capable of forming a network structure and exhibiting good sealing property and bonding performance. Therefore, the small molecules of monomers in the sealant base composition are anchored and the movement thereof is restricted by the network structure. Thus, the contamination to the liquid crystal is effectively reduced.

### FIELD OF THE INVENTION

The present invention relates to the field of display technique. More particularly, the present invention relates to a sealant, a preparing method and a use method thereof, and a liquid crystal display (LCD) panel using the sealant.

### BACKGROUND OF THE INVENTION

Generally, sealants are crosslinked through stepwise polymerization including UV polymerization and heat polymerization. The first step is the UV polymerization which is carried out by irritating the sealant with UV light to induce the photoinitiator in the sealant to produce free radicals. The free radicals subsequently initiate a chain polymerization of the polymerizable, double bond-containing monomers in the sealant, such that a macromolecular network is formed. The second step is the heat polymerization, during which the heat polymerizable monomers are polymerized and farm macromolecules with good mechanical properties. Thus, the substrates (color filter substrate and array substrate) are bonded effectively.

As shown in FIG. 1, an LCD panel includes an array substrate having liquid crystal 1 dropped thereon and a color filter substrate coated with sealant 4 (including monomers 2 represented by the white or gray panes and fillers 3), which are assembled and aligned with each other under vacuum. The sealant 4 is applied on the glass substrate 5 and can bond the array substrate and the color filter substrate upon polymerization and crosslinking. The sealant 4 comprises unpolymerized monomers 2 and organic or inorganic fillers 3 dispersed therein. During the polymerization, the small molecules of the unpolymerized monomers 2 are apt to diffuse into and contaminate the liquid crystal 1. As illustrated in FIG. 1, the small molecules of the unpolymerized monomers 2 and the fillers 3 in the sealant have diffused into the liquid crystal 1.

### SUMMARY OF THE INVENTION

An object of the present invention is to solve the problem that the sealant in the LCD panel of the prior art is apt to contaminate the liquid crystal adjacent thereto. The object is achieved by providing a sealant which is capable of relieving the contamination to liquid crystal.

The sealant according to the present invention comprises a sealant base composition and an ethylene-vinyl acetate copolymer.

Preferably, the mass percent of the ethylene-vinyl acetate copolymer in the sealant is in the range of 0.05-40.0%.

Preferably, the number average molecular weight (Mn) of the ethylene-vinyl acetate copolymer is in the range of 10000-100000.

Preferably, the mass percent of the vinyl acetate monomeric unit in the ethylene-vinyl acetate copolymer is in the range of 5%-45%, and more preferably in the range of 20%-28%.

Preferably, the sealant base composition comprises a heat polymerizable monomer, a UV polymerizable monomer, a heat curing agent and a photoinitiator.

Another object of the present invention is to provide a method for preparing the sealant of the invention. The method comprises the following steps:

1) mixing a sealant base composition and an ethylene-vinyl acetate copolymer to obtain a sealant; and

2) deaerating the sealant obtained in step 1) while keeping it away from light.

Preferably, the mass percent of the ethylene-vinyl acetate copolymer in the sealant is in the range of 0.05-40.0%.

Preferably, the step of deaerating while keeping away from light is performed by centrifugal deaeration away from light for 1-5 hours.

Yet another object of the present invention is to provide an LCD panel comprising an array substrate and a color filter substrate bonded by the sealant of the invention.

Yet another object of the present invention is to provide a method of using the sealant. The method comprises the steps of i) providing the sealant of the invention, and ii) subjecting the sealant to a UV polymerization and a heat polymerization to cure the sealant.

Preferably, the method further comprises applying the sealant provided in step i) onto a frame of a color filter substrate and/or an array substrate.

Preferably, the UV polymerization is performed with UV light having a wavelength of 365 nm at an intensity of 800 mW/cm² or more for 5-30 seconds (s).

Preferably, the heat polymerization is performed under a temperature in the range of 80-140° C. for 20-100 minutes (min).

The sealant of the present invention comprises ethylene-vinyl acetate copolymer which is a linear polymer with a high molecular weight, and which is capable of forming a network structure and exhibiting good sealing property and bonding performance. Therefore, the unpolymerized small molecules (such as heat polymerizable monomer, UV polymerizable monomer and the like) or other components in the sealant base composition are strongly anchored and the movement thereof is highly restricted by the network structure, such that the contamination to the liquid crystal caused by them is effectively reduced.

### BRIEF DESCRIPTION OF THE FIGURES

FIG. 1 is a schematic diagram showing the contamination of a sealant to liquid crystal during the production of an LCD panel of the prior art.

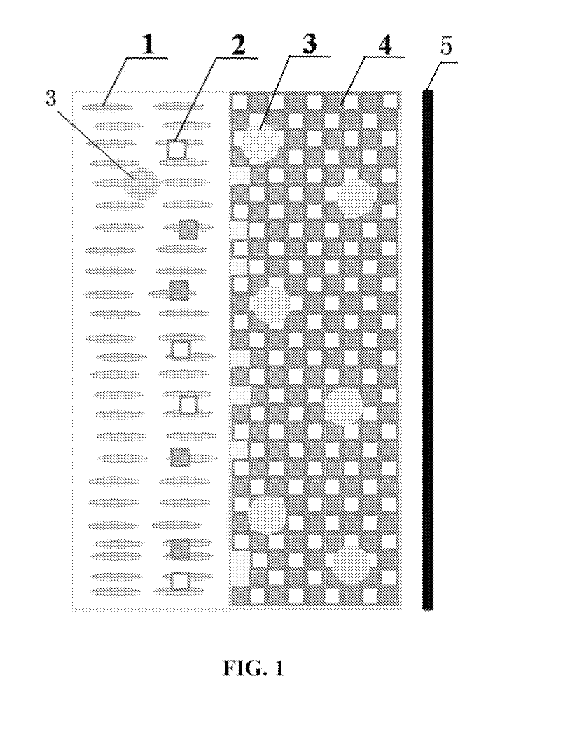

FIG. 2 is a schematic diagram showing the relieved contamination of the sealant according to one embodiment of the present invention to liquid crystal during the production of an LCD panel.

FIG. 3 is a scanning electron micrograph showing the morphology of the ethylene-vinyl acetate copolymer in the sealant according to one embodiment of the present invention.

FIG. 4 is a diagram showing the Fourier transform infrared spectroscopy (FT-IR) of the liquid crystals adjacent to the sealants in the LCD panels produced in Example 2 of the present invention and in Comparative Example, respectively (wavelength range: 1700 cm⁻¹ to 1450 cm⁻¹).

FIG. 5 is a diagram showing the FT-IR spectroscopy of the liquid crystals adjacent to the sealants in the LCD panels produced in Example 2 of the present invention and in Comparative Example, respectively (wavelength range: 1050 cm⁻¹ to 800 cm⁻¹).

### DETAILED DESCRIPTION OF CERTAIN EMBODIMENTS

In order to make those skilled in the art have a better understanding of the technical solutions of the present invention, more detailed description is provided below with reference to specific embodiments and the accompanying drawings.

The present invention provides a sealant comprising a sealant base composition and an ethylene-vinyl acetate copolymer.

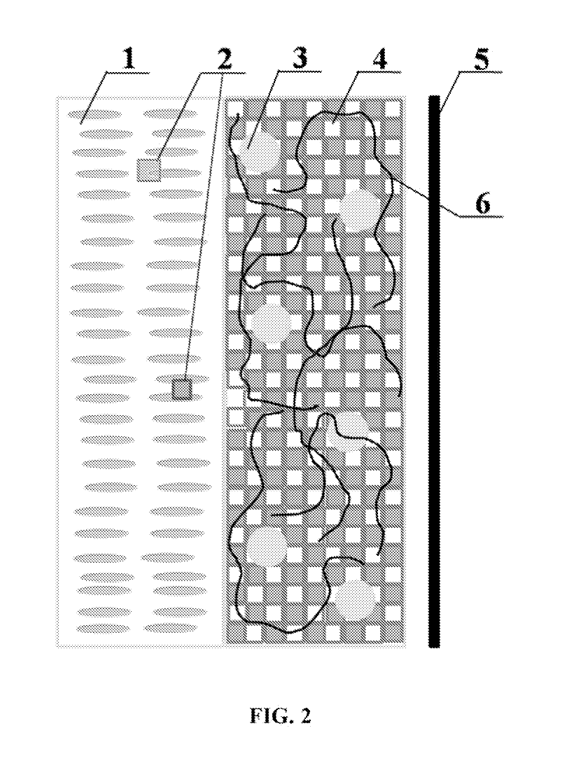

As shown in FIG. 2, the sealant 4 of the present invention comprises ethylene-vinyl acetate copolymer 6 which is a linear polymer with a high molecular weight, and which is capable of forming a network structure and exhibiting good sealing property and bonding performance. Therefore, the unpolymerized small molecules 2 (such as heat polymerizable monomers, UV polymerizable monomers and the like) or other components in the sealant base composition are strongly anchored and the movement thereof is highly restricted by the network structure, such that the contamination to the liquid crystal 1 caused by them is effectively reduced. The diffusion of UV polymerizable monomers and heat polymerizable monomers to the liquid crystal 1 can be effectively inhibited during the process of UV polymerization and heat polymerization.

The effect of relieving the contamination to liquid crystal is influenced by the content of the ethylene-vinyl acetate copolymer in the sealant. When its content is relatively low, the network structure formed in the sealant is sparse. When the content is increased, the network structure in the sealant becomes dense accordingly and therefore the diffusion of small molecules is restricted to a higher degree. As a result, the impact of the liquid crystal to the sealant and the contamination of the sealant to the liquid crystal are relieved. However, the viscosity of the sealant rises with the increase of the content of the ethylene-vinyl acetate copolymer in the sealant, which may influence the uniformity of the coating of the sealant. Thus, preferably, the mass percent of the ethylene-vinyl acetate copolymer in the sealant is in the range of 0.05-40.0%, more preferably in the range of 5-30%, and most preferably in the range of 15-25%.

The ethylene-vinyl acetate copolymer is obtained by copolymerization of ethylene and vinyl acetate and it can be represented by the following structure formula:

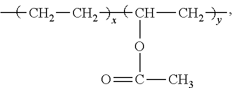

wherein x represents the number of the ethylene monomeric unit and y represents the number of the vinyl acetate monomeric unit. The property of the ethylene-vinyl acetate copolymer is primarily determined by the molecular weight thereof and the content of the vinyl acetate monomeric unit. In the present invention, it is preferably that the Mn of the ethylene-vinyl acetate copolymer is in the range of 10000-100000, more preferably 10000-50000, and most preferably 20000-40000.

The polarity of the acetate group of the vinyl acetate monomer may increase the elasticity and viscosity of the copolymer. When the melt index (determined by both molecular weight and viscosity) is given, the elasticity, flexibility, compatibility and transparency of the copolymer are improved with the increase of the content of the vinyl acetate monomeric unit, which leads to the formation of a network structure with a higher density and a stronger anchoring ability such that the contamination to liquid crystal is prevented more effectively. On the other hand, when the content of the vinyl acetate is giver, the softening point of the copolymer is decreased with the increase of the melt index, which leads to a superior processability and surface gloss. In the present invention, it is preferably that the content of the vinyl acetate monomeric unit in the ethylene-vinyl acetate copolymer is in the range of 5-45 wt %, and more preferably in the range of 20-28 wt %, based on the total weight of the ethylene-vinyl acetate copolymer. Since the ethylene-vinyl acetate copolymer is a linear polymer with a much higher molecular weight and viscosity than the small molecules of unpolymerized monomers, it is capable of forming a macromolecular network structure upon being mixed with the small molecules of monomers.

The ethylene-vinyl acetate copolymers suitable for the present invention are commercially available from the market, for example, from DuPont US, Sumitomo Chemical, Mitsui Chemicals, etc., or may be prepared by copolymerization of ethylene and vinyl acetate through any conventional process known in the art.

It should be appreciated by the person skilled in the art that the term “sealant base composition” used herein refers to a variety of components comprised in any sealant known in the art. For example, the sealant base composition may comprise, but not limited to, a heat polymerizable monomer, such as epoxy resins, which may be selected from bisphenol A type epoxy resin, p-aminophenol triglycidyl epoxy resin, tetrahydrophthalic acid diglycidyl ester epoxy resin, hexahydrophthalic acid diglycidyl ester, and combinations thereof; a UV polymerizable monomer, such as acrylate-based compound, rosin-based compound, etc.; an organic filler such as silica gel, etc.; an inorganic filler such as carbon black, etc.; a heat curing agent such as organic amine, for example, ethylenetriamine, methylene bis(cyclohexylamine), diethylenetriamine, triethylenetetramine, etc.; and a photoinitiator such as camphorquinone or N,N-dimethylaminoethyl methacrylate-diaryliodonium salt, etc. Any other known components comprised in a sealant also fall within the scope of the sealant base composition of the present invention.

The amount of each component in the sealant base composition can be determined according to the conventional sealants in the art. For example, based on the total weight of the sealant, the amount of the heat polymerizable monomer may be 10-89%; the amount of the UV polymerizable monomer may be 10-89%; the amount of the organic filler may be 0-20%; the amount of the inorganic filler may be 0-20%; the amount of the heat curing agent may be 0.1-5%; and the amount of the photoinitiator may be 0.1-5%.

The sealant base composition used in the present invention can be any sealant commercially available from the market, such as BO2920 produced by Mitsui Chemicals, Inc., or UR-2920, S-WB42 and SUR-E709 produced by Sekisui Chemical CO., LTD. It should be appreciated by the person skilled in the art that any other sealant known in the art is also suitable as the sealant base composition of the present invention, as long as the sealant comprises a heat polymerizable monomer (for example, epoxy resin), a UV polymerizable monomer (for example, acrylate-based compound), optionally an organic/inorganic filler, a heat curing agent and a photoinitiator, or substances possess similar properties.

The present invention also provides a method for preparing the sealant described above. The method comprises the following steps:

1) mixing a sealant base composition and an ethylene-vinyl acetate copolymer to obtain a sealant; and

2) deaerating the sealant obtained in step 1) while keeping it away from light.

Preferably, the mass percent of the ethylene-vinyl acetate copolymer in the sealant is in the range of 0.05-40.0%.

Preferably, the step 1) is performed at room temperature.

Preferably, the step of deaerating while keeping away from light is performed by centrifugal deaeration away from light for 1-5 hours. Specifically, the deaeration can be performed in an environment away from light and at room temperature by using SIENOX centrifugal deaerator, or under a pressure of <500 Pa.

The present invention also provides an LCD panel comprising an array substrate and a color filter substrate, wherein the array substrate and the color filter substrate are bonded by the sealant of the present invention.

The present invention also provides a method of using the sealant described above. The method comprises the steps of i) providing the sealant of the present invention, and ii) subjecting the sealant to a UV polymerization and a heat polymerization to cure the sealant. Specifically, in the case that the sealant is used in an LCD panel to be assembled, the LCD panel is obtained by applying the sealant onto the frame of a color filter substrate, and then assembling and aligning the color filter substrate with the array substrate having liquid crystal dropped thereon. Then, a UV polymerization and a heat polymerization are performed so as to bond the two substrates to form the LCD panel.

It should be understood that the UV polymerization and the heat polymerization can be carried out using conventional techniques and equipments known in the art. Preferably, the UV polymerization can be performed with UV light having a wavelength of 365 nm at an intensity of 800 mW/cm² or more for 5-30 s. The heat polymerization is preferably performed under a temperature in the range of 80-140° C. for 20-100 min.

As used in this specification and the appended claims, the words “a”, “an”, and “the”, or cases not indicating quantity, include plural referents unless the content clearly dictates otherwise. Thus, for example, reference to a composition containing “a compound” includes a mixture of two or more compounds. As used in this specification and the appended claims, the term “or” is generally employed in its sense including “and/or” unless the content clearly indicates otherwise.

### EXAMPLES

Advantages and embodiments of the present invention are further illustrated by the following examples, but the particular materials and amounts thereof recited in these examples, as well as other conditions and details, should not be construed to unduly limit the invention.

Examples 1-5 using ethylene-vinyl acetate copolymers and Comparative Example without any ethylene-vinyl acetate copolymer are set forth below. The composition and the parameters for preparing the sealant of each Example and Comparative Example are shown in Table I.

TABLE I
The composition and the parameters of the sealant of each Example and Comparative Example

| | Comparative | Example | Example | Example | Example | Example | Example |
|---|---|---|---|---|---|---|---|
| | Example | 1 | 2 | 3 | 4 | 5 | 6 |
| Mass percent of | 100 | 99.95 | 80 | 95 | 60 | 91 | 80 |
| sealant base | | | | | | | |
| composition | | | | | | | |
| UR-2920 in the | | | | | | | |
| sealant (wt %) | | | | | | | |
| Mass percent of | — | 0.05 | 20 | 5 | 40 | 9 | 20 |
| ethylene-vinyl | | | | | | | |
| acetate copolymer in | | | | | | | |
| the sealant (wt %) | | | | | | | |
| Mn of ethylene-vinyl | — | 50000 | 10000 | 70000 | 100000 | 40000 | 30000 |
| acetate copolymer | | | | | | | |
| Mass percent of vinyl | — | 5 | 35 | 28 | 45 | 20 | 25 |
| acetate monomeric | | | | | | | |
| unit in ethylene-vinyl | | | | | | | |
| acetate copolymer (wt %) | | | | | | | |
| Duration of | — | 2 | 3 | 4 | 5 | 1 | 3 |
| deaeration away | | | | | | | |
| from light (h) | | | | | | | |

The processes for preparing the sealant and the LCD panel of the present invention are described hereinafter by taking Example 2 as a representative. The materials and devices used are described below:

Ethylene-vinyl acetate copolymer: Mn: 10000; mass percent of the vinyl acetate monomeric unit in the copolymer: 35 wt %; available from Mitsui Chemicals, Inc.

Sealant base composition UR-2920: available from Sekisui Chemical CO., LTD.

Array substrate and color filter substrate: available from Corning Incorporated.

Scanning electron microscope: Zeiss EVO18, available from Zeiss Company.

Fourier transform infrared spectrometer: Perkin Elmer Spectrum One spectrometer (KBr disc method)

The sealant was prepared by the following process. The sealant base composition and the ethylene-vinyl acetate copolymer in a mass ratio of 80%/20% were mixed uniformly at room temperature. The resultant mixture was deaerated away from light at a pressure of 200 Pa and room temperature for 3 h.

The sealant was applied onto an array substrate to make the wetted area of the array substrate up to 2800 μm². The sealant was irradiated with UV light having a wavelength of 365 nm at an intensity of 1200 mW/cm² for 10 s, such that the UV polymerizable monomer in the sealant was precured. Then, the sealant was completely cured by heating at 120° C. for 70 min, and thus the array substrate and the color filter substrate were bonded thereby.

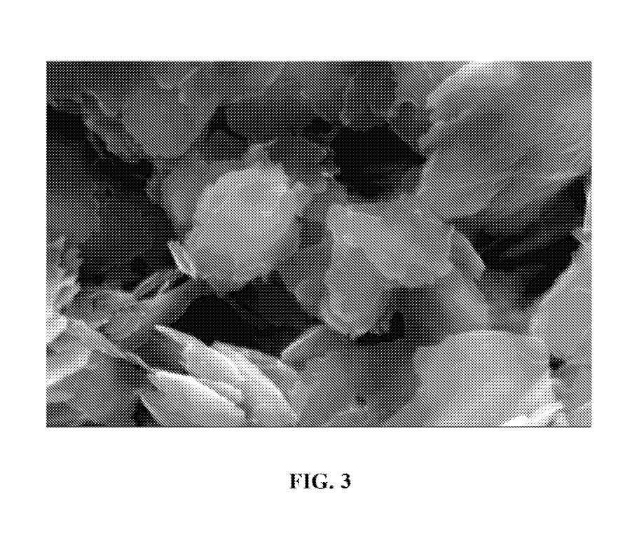

An experiment was performed to observe the morphology of the ethylene-vinyl acetate copolymer in the sealant. The sealant base composition and the ethylene-vinyl acetate copolymer in a mass ratio of 80%/20% were mixed uniformly at room temperature. The resultant mixture was deaerated away from light at a pressure of 200 Pa and room temperature for 3 h. Then, the mixture was applied onto a glass substrate to make the wetted area of the substrate up to 2800 μm². The sealant was irradiated with UV light having a wavelength of 365 nm at an intensity of 1200 mW/cm² for 10 s, such that the UV polymerizable monomer in the sealant was precured. After the UV polymerization, the glass substrate was washed with dichloromethane to remove the small molecules. Then, the morphology of the ethylene-vinyl acetate copolymer was observed by the scanning electron microscope. As shown in FIG. 3, the ethylene-vinyl acetate copolymer exhibits a network skeleton structure and a micromorphology of thin sheets, which can stabilize small molecules in the tiny meshes thereof, and thus anchor the alignment of the small molecules and inhibit the movement of the small molecules.

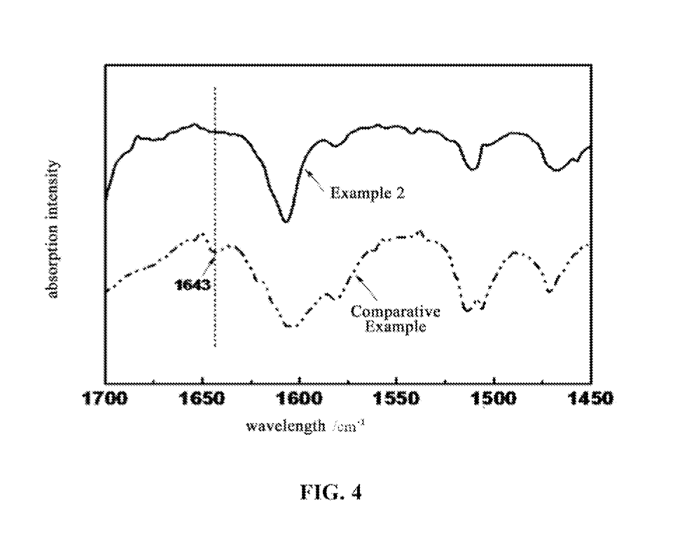

The liquid crystals adjacent to the sealants in the LCD panels produced in Example 2 and Comparative Example were sampled randomly and were tested by FT-IR spectroscopy, respectively. For the liquid crystal of Example 2, the characteristic absorption peak at 1643 cm⁻¹ of the UV polymerizable monomer had an absorption intensity of 5%, which was weaker than that of the characteristic absorption peak at 1643 cm⁻¹ of the UV polymerizable monomer in the liquid crystal of Comparative Example (absorption intensity: 50%), as shown in FIG. 4. These results demonstrated that the liquid crystal of Example 2 contained much less UV polymerizable monomer than the liquid crystal of Comparative Example. Therefore, the sealant comprising ethylene-vinyl acetate copolymer prepared in Example 2 contaminated the liquid crystal much less than the sealant without any ethylene-vinyl acetate copolymer prepared in Comparative Example.

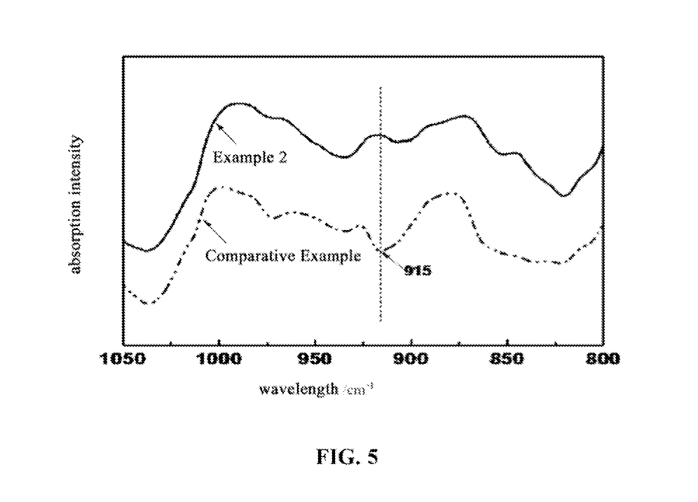

Again, the liquid crystals adjacent to the sealants in the LCD panels produced in Example 2 and Comparative Example were sampled randomly and were tested by FT-IR, respectively. For the liquid crystal of Example 2, the characteristic absorption peak at 915 cm⁻¹ of the heat polymerizable monomer had an absorption intensity of 10%, which was weaker than that of the characteristic absorption peak at 915 cm⁻¹ of the heat polymerizable monomer in the liquid crystal of Comparative Example (absorption intensity: 60%), as shown in FIG. 5. These results also demonstrated that the liquid crystal of Example 2 contained much less heat polymerizable monomer than the liquid crystal of Comparative Example. Therefore, the sealant comprising ethylene-vinyl acetate copolymer prepared in Example 2 contaminated the liquid crystal much less than the sealant without any ethylene-vinyl acetate copolymer prepared in Comparative Example.

It can be seen from FIGS. 4 and 5 that the addition of an ethylene-vinyl acetate copolymer in the sealant can inhibit the diffusion of UV polymerizable monomer and heat polymerizable monomer to the liquid crystal, because of the network structure formed by the ethylene-vinyl acetate copolymer. However, in the case of the sealant without any ethylene-vinyl acetate copolymer, UV polymerizable monomer and heat polymerizable monomer diffuse into the liquid crystal during the process of UV polymerization and heat polymerization and thus cause contamination to the liquid crystal.

Sealants and LCD panels of Examples 1, 3 and 4-6 were prepared in a similar manner as described with respect to Example 2, except those variables listed in Table I. These LCD panels were also tested by FT-IR at the same conditions as in Example 2, and good results were obtained as well. The results are reported below:

Example 1: the absorption intensity at 1643 cm⁻¹: 40%;
the absorption intensity at 915 cm⁻¹: 50%;

Example 3: the absorption intensity at 1643 cm⁻¹: 20%
the absorption intensity at 915 cm⁻¹: 30%;

Example 4: the absorption intensity at 1643 cm⁻¹: 3%
the absorption intensity at 915 cm⁻¹: 5%;

Example 5: the absorption intensity at 1643 cm⁻¹: 8%
the absorption intensity at 915 cm⁻¹: 18%; and

Example 6: the absorption intensity at 1643 cm⁻¹: 2%
the absorption intensity at 915 cm⁻¹: 3%.

These results also demonstrate that the addition of an ethylene-vinyl acetate copolymer in a sealant can inhibit the diffusion of UV polymerizable monomer and heat polymerizable monomer to the liquid crystal.

It should be understood that the present invention is not intended to be limited to the embodiments set forth above for illustrative purposes. Various modifications and alterations of the invention will be apparent to those skilled in the art without departing from the scope and spirit of the invention. Such modifications and alterations are included in the scope of the present invention.

1. A sealant comprising a sealant base composition, characterized in that the sealant further comprises an ethylene-vinyl acetate copolymer.

2. The sealant according to claim 1, characterized in that the mass percent of the ethylene-vinyl acetate copolymer in the sealant is in the range of 0.05-40.0%.

3. The sealant according to claim 1, characterized in that the number average molecular weight of the ethylene-vinyl acetate copolymer is in the range of 10000-100000.

4. The sealant according to claim 1, characterized in that the mass percent of the vinyl acetate monomeric unit in the ethylene-vinyl acetate copolymer is in the range of 5%-45%.

5. The sealant according to claim 4, characterized in that the mass percent of the vinyl acetate monomeric unit in the ethylene-vinyl acetate copolymer is in the range of 20%-28%.

6. The sealant according to claim 1, characterized in that the sealant base composition comprises a heat polymerizable monomer, a UV polymerizable monomer, a heat curing agent and a photoinitiator.

7. A method for preparing a sealant, characterized in that the method comprises the following steps:
1) mixing a sealant base composition and an ethylene-vinyl acetate copolymer to obtain a sealant; and
2) deaerating the sealant obtained in step 1) while keeping it away from light.

8. The method according to claim 7, characterized in that the mass percent of the ethylene-vinyl acetate copolymer in the sealant is in the range of 0.05-40.0%.

9. The method according to claim 7, characterized in that the step of deaerating while keeping away from light is performed by centrifugal deaeration away from light for 1-5 hours.

10. A liquid crystal display panel comprising an array substrate and a color filter substrate bonded by a sealant, characterized in that the sealant comprises a sealant base composition and an ethylene-vinyl acetate copolymer.

11. A method of using a sealant, comprising the following steps:
i) providing a sealant that comprises a sealant base composition and an ethylene-vinyl acetate copolymer; and
ii) subjecting the sealant to a UV polymerization and a heat polymerization to cure the sealant.

12. The method according to claim 11, further comprising:
applying the sealant provided in step i) onto a frame of a color filter substrate and/or an array substrate.

13. The method according to claim 11, wherein the UV polymerization is performed with UV light having a wavelength of 365 nm at an intensity of 800 mW/cm² or more for 5-30 s.

14. The method according to claim 11, wherein the heat polymerization is performed under a temperature in the range of 80-140° C. for 20-100 min.
